(19) United States
(12) Patent Application Publication
(10) Pub. No.: US 2025/0060543 A1
(43) Pub. Date: Feb. 20, 2025

(54) A SMALL FORM-FACTOR PLUGGABLE DOUBLE-DENSITY MULTIPLE PASSIVE OPTICAL NETWORK MODULE

(71) Applicants: ALTICE LABS, S.A., Aveiro (PT); PICADVANCED, S.A., Ílhavo (PT)

(72) Inventors: Cláudio Emanuel GOMES FERREIRINHO LIMA RODRIGUES, Aveiro (PT); Paulo Jorge DA COSTA MÃO CHEIA, Aveiro (PT); Joaquim Fernando VALE E SERRA, Aveiro (PT); Alfonso Carlos ANTERO MIRANDA FIGUEIREDO, Aveiro (PT); Luis Miguel AMARAL HENRIQUES, Aveiro (PT); Ana Cristina MAIA TAVARES, Ílhavo (PT); Francisco Manuel RUIVO RODRIGUES, Ílhavo (PT); António Luís DE JESUS TEIXEIRA, Ílhavo (PT)

(21) Appl. No.: 18/723,326

(22) PCT Filed: Dec. 22, 2022
(86) PCT No.: PCT/IB2022/062669

§ 371 Date: Jun. 21, 2024

(30) Foreign Application Priority Data
Dec. 23, 2021 (PT) 117687

(51) Int. Cl. G02B 6/42; G02B 6/293; G02B 6/38

(52) U.S. Cl. CPC G02B 6/4215; G02B 6/29364; G02B 6/3893; G02B 6/4246; G02B 6/4292

(57) ABSTRACT

The present invention relates to a Small Form-Factor Pluggable Double Density Multiple Passive Optical Network Module, projected to provide a connection for 25GS-PON, XGS-PON, and GPON, and to be incorporated in any state-of-the-art SFP-DD transceiver host to allow double multi-PON OLT channels. The module comprises a case housing a specific set of technical elements such as a Hexa-bidirectional optical subassembly, a high-speed electrical interface, a control unit, a printed circuit board and a flex-printed circuit board to ensure proper assembly and electronic performance of all elements.

### FIELD OF THE INVENTION

The present invention is enclosed in the area of Gigabit passive optical network (GPON), 10 Gigabit-capable symmetric passive optical network (XGS-PON), and 25 Gigabit symmetric passive optical network (25GS-PON) optical line terminals (OLT), particularly in the field of small form-factor pluggable modules double density (SFP-DD).

### PRIOR ART

Gigabit-capable Passive Optical Network (GPON) has been widely spread among operators allowing the distribution of high bandwidth, large coverage, and providing high efficiency to deliver broadband. Based on International Telecommunication Union—Telecommunication Standardization Sector (ITU-T) G.984.x. GPON-OLTs commonly use small form-factor pluggable (SFP) transceiver hosts equipped with SFPs in a single fiber bidirectional SC connector configuration for carrying out the transmission and reception of the passive optical network (PON) data.

10 Gigabit-capable symmetric Passive Optical Network (XGS-PON) is spreading among operators allowing the distribution of very high bandwidth, large coverage, and providing high efficiency to deliver broadband. It is a PON technology capable of coexisting in the same physical network with legacy GPON ITU-T G.984.x—by using different downstream and upstream wavelengths. XGS-PON is based on ITU-T G.907.x. XGS-PON Optical Line Terminals (OLTs) commonly use SFP plus transceiver hosts equipped with 10Gigabit SFP plus in a single fiber bidirectional SC connector configuration for carrying out the transmission and reception of the 10 Gigabit passive optical network (PON) data.

25 Gigabit Symmetric Passive Optical Network (25GS-PON) is a new PON technology delivering 25 Gigabit per second symmetric bandwidth. It is a PON technology capable of coexisting in the same physical network with legacy GPON based on ITU-T G.984.x and XGS-PON based on ITU-T G.907. x by using different downstream and upstream wavelengths. The 25GS-PON is based on 25GS-PON Multisource Agreement (MSA).

SFPs comprise a metallic case, a printed circuit board (PCB), a Bi-Directional Optical Sub-Assembly (BOSA), and flexible PCBs to connect the BOSA to the PCB. BOSA comprises a metal housing with a Transmitter Optical Sub-Assembly (TOSA) for optical transmitting, a Receiver Optical Sub-Assembly (ROSA) for optical receiving, an optical fiber or an optical connector to connect an optical fiber which connects to the external network and a device used to route the light to and from the optical fiber.

### Problem to be Solved

Current PON optical transceiver modules for GPON, XGS-PON, or 25GS-PON support just one of the prior PON technologies, this is, by employing a bidirectional SC connector, a single SFP, SFP+or SFP28 is adapted to feed a GPON, an XGS-PON or a 25GS-PON, limiting the number of users connected to the said host and thereby limiting also its density. The coexistence of the several PON technologies is only possible by the use of external passive coexistence elements.

The present invention addresses the above problem.

### SUMMARY OF THE INVENTION

The present invention relates to a Small Form-factor Pluggable Double-Density Multiple Passive Optical Network Module (SFPDD-MPM), projected to provide a connection to one optical fiber connector of a PON, and to be incorporated in any state-of-the-art OLT supporting GPON, XGS-PON, and 25GS-PON.

Due to the set of technical features that characterizes the SFPDD-MPM optical module developed, it is possible to triple the density of a transceiver, that is, for the same cage space, it allows the coexistence of the three PON technologies. The SFPDD-MPM allows the transmitting and receiving of 3 PON channels in a single optical transceiver.

### DESCRIPTION OF FIGURES

FIG. 1 is a schematic diagram of the SFPDD-MPM optical module developed, according to certain aspects of the invention. The numerical references represent:
10—SFPDD-MPM optical module;
110—hexa bidirectional optical subassembly;
111—control unit;
112—high-speed electrical interface;
113—case;
114—flex-printed circuit board;
115—printed circuit board.

FIG. 2 Erro! A origem da referência não foi encontrada. is a schematic diagram of the SFPDD-MPM module's control unit, according to certain aspects of the invention. The numerical references represent:
111—control unit;
112—high-speed electrical interface;
114—flex-printed circuit board;
210—modulation sub-unit;
220—microcontroller;
230—power supply.

FIG. 3 is a diagram of the SFPDD-MPM module contact assignment of the 40 pins high-speed electrical interface (HSEI) to the SFPDD transceiver host to support the GPON, XGS-PON, and 25GS-PON according to certain aspects of the invention.

The module contact assignment is defined as:
Pin number 1—GPON TD+—Transmit Non-Inverted GPON Data Input;
Pin number 2—GPON TD—Transmit Inverted GPON Data Input;
Pin number 3—GND—Module ground;
Pin number 4—SDA—2-Wire Serial Interface Data Line;
Pin number 5—SCL—2-Wire Serial Interface Clock;
Pin number 6—GPON RD—Receive Burst Mode Inverted GPON1 Data output;
Pin number 7—Reset/Rateselect—Reset Receiver Burst Mode XGS-PON, Rate select for XGS-PON or XG-PON upstream bursts;
Pin number 8—XGSPON SD—Receiver Signal Detect indicator for XGS-PON receiver;
Pin number 9—Trig_TxDisable—Two signals multiplex, which is selected by register: Receiver signal strength indication trigger and transmitter disable for GPON and XGS-PON;
Pin number 10—GPON RD+—Receive Burst Mode Non-Inverted GPON Data output;
Pin number 11—GND-module ground;
Pin number 12—XGSPON RD—Receive Burst Mode Inverted XGSPON Data output;
Pin number 13—XGSPON RD+—Receive Burst Mode Non-Inverted XGSPON Data output;
Pin number 14—GPON_SD—Receiver Signal Detect indicator for GPON receiver;
Pin number 15—VccR—power supply for the receiver;
Pin number 16—VccT—power supply for the transmitter;
Pin number 17—GPON Reset—Reset Receiver Burst Mode GPON;
Pin number 18—XGSPON_TD+-Transmit Non-Inverted XGS-PON Data Input;
Pin number 19—XGSPON TD--Transmit Inverted XGS-PON Data Input;
Pin number 20—GND—Module ground;
Pin number 21—GND—Module ground;
Pin number 22—TX_Fault—25GS-PON Transmitter fault output indication;
Pin number 23—TX_Disable—25GS-PON Transmitter disable;
Pin number 24—NC—Not connected;
Pin number 25—NC—Not connected;
Pin number 26—GND—Module ground;
Pin number 27—Reset/Rateselect—Reset Receiver Burst Mode 25GS-PON, Rate select for 10G or 25G upstream bursts;
Pin number 28—25GSPON RXSD—Receiver Signal Detect indicator for the 25GS-PON receiver;
Pin number 29—Trig—Receiver indication trigger for 25GS-PON;

signal strength
Pin number 30—GND-Module ground;
Pin number 31—GND-Module ground;
Pin number 32—25GSPON_RD—Receive Burst Mode Inverted 25GS-PON Data output;
Pin number 33—25GSPON RD+—Receive Burst Mode Non-Inverted XGS-PON Data output;
Pin number 34—GND—Module ground;
Pin number 35—VccR—power supply for the receiver;
Pin number 36—VccT—power supply for the transmitter;
Pin number 37—GND—Module ground;
Pin number 38—25GS—PON_TD+—Transmit Non-Inverted 25GS-PON Data Input;
Pin number 39—25GS-PON TD—Transmit Inverted 25GS-PON Data Input;
Pin number 40—GND—module ground

FIG. 4 is a schematic diagram of a Hexa bidirectional optical subassembly (BOSA) (110) package for use in the transceiver module shown in FIG. 1. The Hexa-BOSA (110) package comprises a housing with an optical coupling receptacle (401) on one end and the other end along the same axis there is a transmitter optical subassembly (TOSA) (407). Between the optical coupling receptacle (401) and the TOSA (407), and on a perpendicular axis, there are two more TOSAs and three receiver optical subassemblies (ROSAs), which can be positioned both above and/or below the axis, but with the optical interface turned to the interior of the housing. A first ROSA (402) is positioned below the mentioned axis, being the closest to the optical coupling receptacle (401). The second closest subassembly is a second ROSA (403), positioned above the axis. The third closest subassembly is a third ROSA (404), positioned below the axis. Keeping in the same direction there is a first TOSA (405), positioned above the axis, and then a second TOSA (406), positioned below the axis.

FIG. 5 illustrates the optical routing scheme (500) that may be employed in a Hexa-BOSA such as module (110). The optical routing scheme may be attained using several wavelength division multiplexer (WDM) filters which may be coated such that one wavelength, different in each filter, may be reflected and the rest of the spectrum pass through it. These filters are represented by numbers (408), (409), (410), (411), and (412). The wavelength reflected in each filter shall be the same as the one used on the TOSA or ROSA aligned with the respective WDM filter. In this way, a wavelength from a TOSA is reflected on the filter and routed to the optical fiber or optical coupling receptacle. In the same way, a signal received from the optical fiber or the optical coupling receptacle shall pass the filter, except for one wavelength that should be reflected by the filter to be received on the ROSA.

FIG. 6 is a view of the case of the SFPDD-MPM's optical module developed with a single SC connector for integrating the Hexa-bosa, according to certain aspects of the invention. The numerical references represent:
610—MSA height of the rear part;
620—MSA width of the rear part;
630—MSA length of the transceiver, rear part;
640—front length;
650—front width;
660—front height;
670—total length of the transceiver.

FIG. 7 is an exploded view of the case and internal components of the SFPDD-MPMoptical module developed with a dual SC connector, according to certain aspects of the invention. The numerical references represent:
110—Hexa-bidirectional optical sub-assembly.
114—printed circuit board;
710—bottom case;
720—top case;
730—actuator tines;
740—pull-tab;
750—SC hexa-bidirectional optical sub-assembly support;
760—case spacer.

### DETAILED DESCRIPTION

The following detailed description has references to the figures. Parts that are common in different figures have been referred to using the same numbers. Also, the following detailed description does not limit the scope of the disclosure.

The present invention relates to an SFPDD-MPM optical module comprising a single SC connector, projected to be connected in an SFP-DD transceiver host, allowing it to operate in GPON, XGS-PON, and 25GS-PON transmitter and receiver simultaneously.

According to the main embodiment of the invention, the SFPDD-MPM optical module (10) is comprised of at least a hexa-bidirectional optical subassembly (110)—Hexa-BOSA -, a control unit (111) comprising connection and processing means adapted to drive and control said Hexa-BOSA (110) and a high-speed electrical interface—HSEI—(112) adapted to provide connection to the SFP-DD transceiver host Optical Network Units. These elements comprising the SFPDD-MPM optical module (10) are housed in a case (113) which is to be installed inside the SFP-DD transceiver host cage of a GPON, XGS-PON, and 25GS-PON OLT.

FIG. 1 illustrates the block diagram of an exemplary embodiment of the SFPDD-MPM optical module (10) of the invention. It is comprised of the case (113) housing one Hexa-BOSA (110) for GPON, XGS-PON, and 25GS-PON connection, the control unit (111), and the high-speed electrical interface (112).

The Hexa-BOSA (110) is composed of a laser working on the 25GS-PON downstream wavelength at 24.88 Gbit/s, a dual-rate burst mode receiver working on the 25GS-PON upstream wavelength at 9.95 Gbit/s and 24.88 Gbit/s, a laser working on XGS-PON downstream wavelength at 9.95 Gbit/s, a dual-rate burst mode receiver working on XGS-PON upstream wavelength at 2.48 Gbit/s and 9.95 Gbit/s, a laser working on GPON downstream wavelength at 2.48 Gbit/s and a burst mode receiver working on GPON upstream wavelength at 1.24 Gbit/s. The Hexa-BOSA (110) further includes an SC ferrule to allow the connection to an SC optical fiber connector.

The control unit (111) is shown in FIG. 2 and is adapted to control the Hexa-BOSA (110). For that purpose, the control unit (111) comprises three modulation sub-units (210) and a microcontroller (220), besides the required circuit electronics that comprise resistors, capacitors, power supply (230), and ferrite bead. The modulation sub-units (210) comprise laser drivers and limiting amplifiers adapted to drive and modulate the specific technology lasers and to amplify the electrical signals from the single and dual-rate burst mode receivers of Hexa-BOSA (110). The microcontroller (220) is configured to control the modulation sub-units (210) and to communicate with the SFP-DD host through the HSEI (112). The microcontroller (210) is also configured to control the Hexa-BOSA power supplies (230). In one embodiment, the Hexa-BOSA (110) is connected to the control unit (111) through six flex printed circuit boards (114). More particularly, the Hexa-BOSA (110) is connected to the modulation sub-units (210) of the control unit (111), and in particular to the respective laser driver and limiting amplifier through the flexible printed circuit board (114), to guarantee the electronic performance. In another embodiment, the control unit (111) is mounted in a printed circuit board (115) containing all the necessary electrical connections between the different elements to control and drive the Hexa-BOSA (110).

The forty pin HSEI (112) is configured to provide a high-speed interconnection to the SFP-DD transceiver host, to transmit electrical signals that were transformed by the SFPDD-MPM optical module (10) from the different PON data received. Similarly, the SFPDD-MPM optical module (10) may receive electrical signals from the SFP-DD transceiver host via said port connector, to be transformed to optical signals and sent to a fiber network via optical connection.

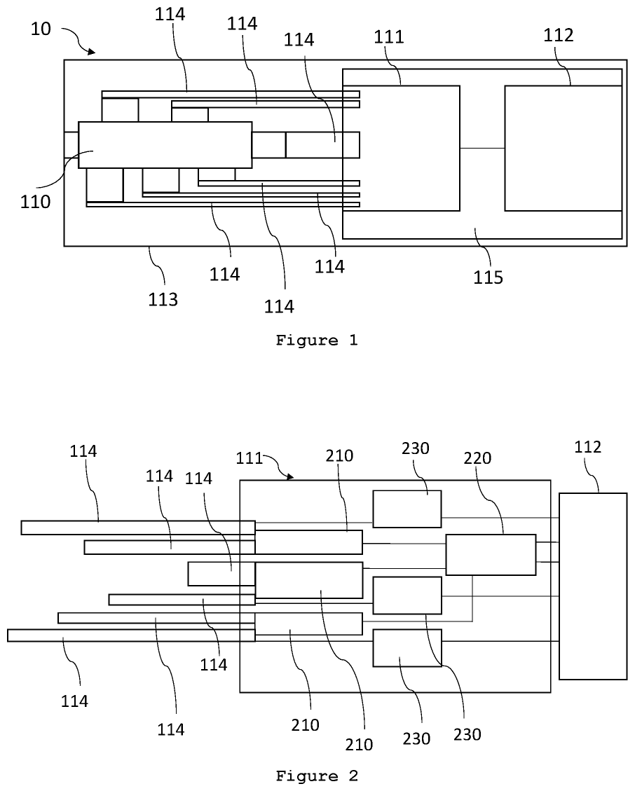

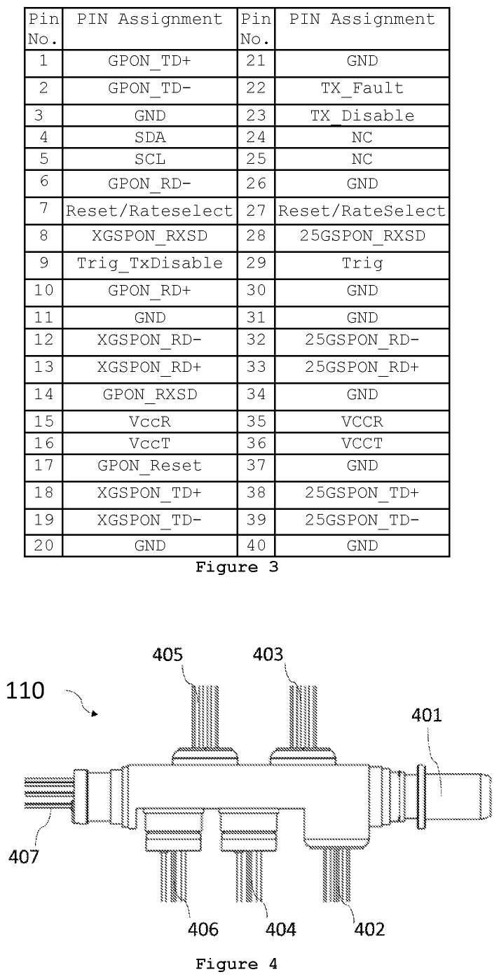

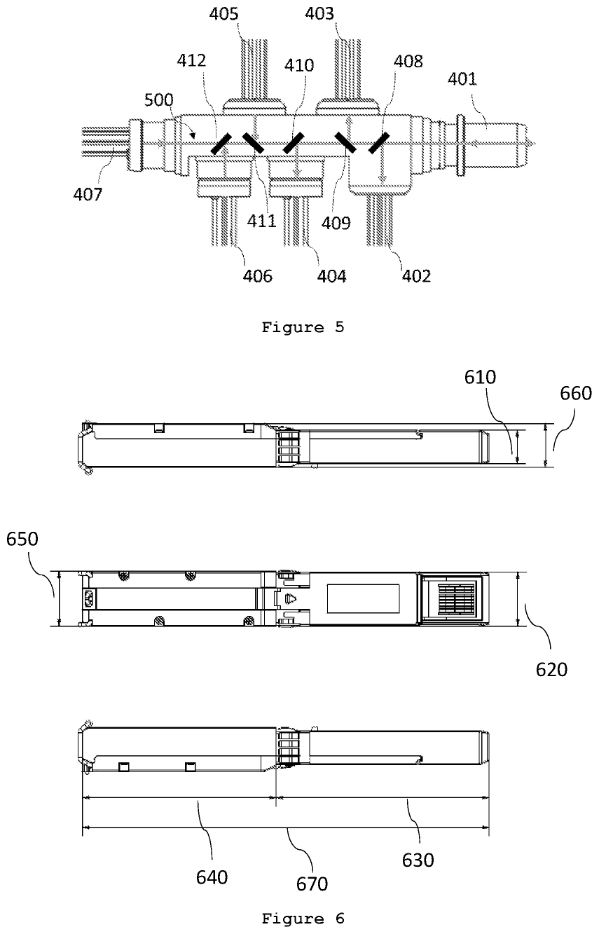

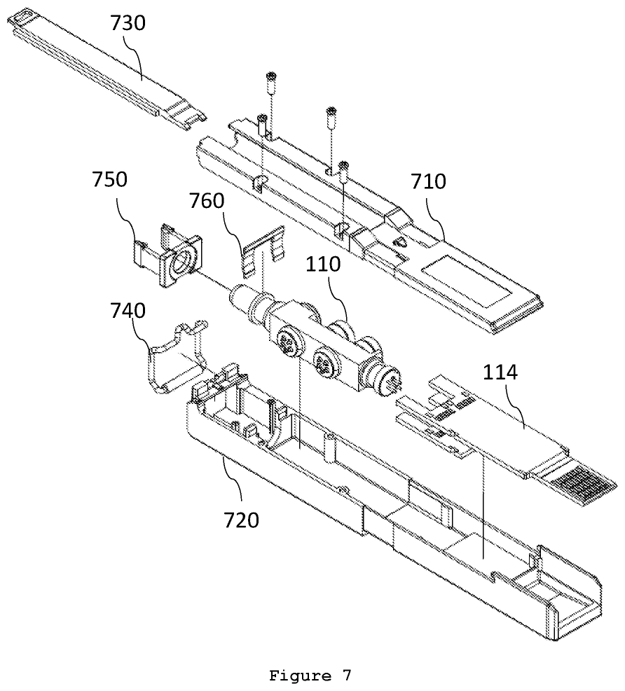

For the connection with the SFP-DD transceiver host, the HSEI (112) comprises a port connector including a plurality of connection pins. In a particular embodiment, the port connector of the forty pins HSEI (112) is provided with a specific contact assignment, to ensure adaptability and compatibility with the state-of-the-art SFP-DD transceiver hosts. Under a particular embodiment of the HSEI (112), FIG. 3 depicts a port connector and respective receptacle which is comprised of forty pins. In the embodiment illustrated in FIG. 3, pin 9 is used to both disable the GPON and XGS-PON lasers transmission and to measure the optical input power on the receivers of the GPON and XGS-PON Hexa-BOSA, representing the remote signal strength indication-RSSI. This pin function is selected on a memory pin map of the SFP-DD module, through the SDA (data line) and SCL (clock line) pins, stored on the memory of the microcontroller (220), to act as transmitter disable of the GPON and XGS-PON of the Hexa-BOSA (110), or as RSSI of the GPON and XGS-PON of the Hexa-BOSA (110).

FIG. 4 illustrates a possible schematic realization of a Hexa-BOSA. In this representation, there are three transmitters and three receivers, each one for transmitting or receiving at a different wavelength, according to the technology of choice. The Hexa-BOSA may be comprised by three ROSAS (402, 403, 404), each in a transistor outline (TO) package, three TOSAs (405, 406, 407), each in a TO package, five WDM filters (408, 409, 410, 411, 412) and five slots to mount the WDM filters, and by an optical coupling receptacle (401) with an optical fiber attached and which is in optical communication with all the TOSAs (405, 406, 407) and ROSAs (402, 403, 404) inside the package. Particularly, all the ROSAs (402, 403, 404) and TOSAs (405, 406, 407) are misaligned between each other, and all the WDM filters (408, 409, 410, 411, 412) are placed at an angle of about fourth-five degrees concerning the direction of light coming from or going to the optical fiber, and each WDM filter (408, 409, 410, 411, 412) is aligned with the respective ROSA (402, 403, 404) or TOSA (405, 406, 407), regarding the wavelength that the WDM filter reflects.

FIG. 5 represents the optical routing scheme inside the Hexa-BOSA (110). The basic element to achieve this optical routing scheme is a group of wavelength division multiplexer (WDM) filters, positioned in front of each TOSA and ROSA. A wavelength from a TOSA is reflected on the filter and routed to the optical optical coupling receptacle. In the same way, a signal received from the optical fiber or the optical coupling receptacle shall pass the filter, except for one wavelength that should be reflected by the filter to be received on the ROSA.

FIG. 6 illustrates the mechanical case (113) design of the SFPDD-MPM optical module (10) developed. It assumes a standard SFP-DD Transceiver Multisource Agreement (MSA) size inside a cage assembly: MSA height of the rear part (610), MSA width of the rear part (620), and MSA length of transceiver outside of the cage to rear (630) to fit on a standard SFP-DD Cage Assembly of the SFP-DD transceiver host. The SFPDD-MPM optical module (10) dimensions outside of the cage MSA, to fit the Hexa-bosa and an SC connector, assume a specific front length (640) of 49, 25 mm, front width (650) of 14 mm, and a front height (660) of 12 mm. The total length of the transceiver (670) is 103,40 mm.

The SFPDD-MPM optical module comprises a case (113) which includes an SC BOSA support (750) and a case spacer (760) adapted to accommodate the installation of the Hexa-BOSA (110). Additionally, and as shown in FIG. 7, the case (113) may also comprise other mechanical parts such as a bottom case (710), a top case (720), one actuator tine (730) to allow the extraction of the SFPDD-MPM optical module (10) from the SFP-DD transceiver host case, and a pull-tab (740) to allow to manually pull the SFPDD-MPM optical module (10).

The SFPDD-MPM optical module mechanical parts, (710), (720), (730), (740), (760) are made from several types of metallic materials as zinc alloys, zamak 2, zamak 3, or aluminum. The SC BOSA supports (750) are manufactured in plastic or metal.

The physical geometry of the SFPDD-MPM optical module (10) developed is to be such that it may fit within the receptacle case of a conventional GPON and XGS-PON OLT transceiver.

The SFPDD-MPM optical module (10) developed may be one of the multiple SFPDD-MPM optical modules (10) incorporated into SFP-DD transceiver hosts of a GPON, XGS-PON, and 25GS-PON OLT. In certain embodiments, inserting an SFPDD-MPM optical module (10) into an SFP-DD transceiver host configured to operate just in GPON, XGS-PON or 25GS-PON may result in the SFPDD-MPM optical module (10) being only able to establish a single optical connection.

As will be clear to one skilled in the art, the present invention should not be limited to the embodiments described herein, and several changes are possible which remain within the scope of the present invention.

Of course, the preferred embodiments shown above are combinable, in the different possible forms, being herein avoided the repetition of all such combinations.

1. A Hexa-bidirectional optical subassembly
Hexa-BOSA—package comprising:
three receiver optical subassemblies—ROSA—, each in a transistor outline (TO) package;
three transmitter optical subassemblies—TOSA—, each in a TO package;
five wavelength division multiplexing filters—WDM filter—and five slots to mount the WDM filters; and
an optical coupling receptacle with an optical fiber attached and which is in optical communication with all the TOSAs and ROSAs inside the package;
wherein,
all the ROSAs and TOSAs are misaligned between each other;
and wherein
all the WDM filters are placed at an angle of about fourth-five degrees concerning a direction of light coming from or going to the optical fiber, and
each WDM filter is aligned with the respective ROSA or TOSA, regarding the wavelength that the WDM filter reflects.

2. The Hexa-BOSA according to claim 1, comprising:
a first laser, adapted to operate on a twenty-five-gigabit passive optical network—25GS-PON—downstream wavelengths at 24,88 Gbit/s;
a second laser adapted to operate on a ten-gigabit passive optical network—XGS-PON downstream wavelengths at 9.95 Gbit/s; and
a third laser adapted to operate on a two-point-five gigabit passive optical network—GPON—, downstream wavelengths at 2.48 Gbit/s.

3. The Hexa-BOSA according to claim 2, further comprising:
a first dual-rate burst mode receiver adapted to operate on the 25GS-PON upstream wavelength at 9.95 Gbit/s and 24.88 Gbit/s;
a second dual-rate burst mode receiver adapted to operate on the XGS-PON upstream wavelength at 2.48 Gbit/s and 9.95 Gbit/s; and
a burst mode receiver adapted to operate on the GPON upstream wavelength at 1.24 Gbit/s.

4. The Hexa-BOSA according to any of the previous claim 1, further comprising an SC ferrule adapted to provide connection to an SC optical fiber connector.

5. A small form-factor pluggable double-density multiple passive optical network module—SFPDD-MPM—projected to be incorporated in a small form-factor double density—SFP-DD—transceiver host of a 25GS-PON optical network line—OLT—, XGS-PON-OLT and GPON-OLT; the optical module being characterized by comprising:
a case housing:
at least a Hexa-BOSA according to the claim 1;
a control unit comprising connection and processing means adapted to drive and control the Hexa-BOSA;
a high-speed electrical interface—HSEI—adapted to provide connection to a SFP-DD transceiver host of a GPON, XGS-PON, and 25GS-PON OLT.

6. The module according to claim 5, wherein the control unit comprises:
a modulation sub-unit comprising three laser drivers and three limiting amplifiers elements, adapted to drive and modulate the lasers and to amplify electrical signals from a single and dual-rate burst mode receiver of the Hexa-BOSA; and
a microcontroller configured to communicate with the SFP-DD transceiver host through the HSEI and to control an operation of the modulation sub-unit.

7. The module according to claim 6, wherein the connection between the Hexa-BOSA and the respective laser driver and limiting amplifier of each modulation sub-unit is provided through a flex printed circuit board.

8. The module according claim 5, wherein the HSEI is a forty-pin high speed electrical interface, being configured to provide connection to the SFP-DD transceiver host where the SFPDD-MPM is incorporated employing a port connector.

9. The module according to claim 8, wherein the port connector is comprised by a plurality of pins, and wherein a microcontroller further comprises memory means adapted to store a memory pin map of the port connector; the microcontroller being further programmed to select a pin function of each pin of the port connector based on the memory pin map; optionally, the port connector is comprised of forty pins.

10. The module according to claim 1, wherein a case comprises at least one SC Hexa-BOSA support and at least a case spacer to accommodate an installation of at least one Hexa-BOSA.

11. The module according to claim 10, wherein the SC Hexa-BOSA support is made from a plastic material.

12. The module according to claim 10, wherein the case further comprises:
a bottom and a top part;
one actuator tine adapted to allow an extraction of the module from a host case of the SFP-DD transceiver where it is incorporated;
a pull-tab allow a manual pull of the module.

13. The module according to claim 10 wherein a support, a case spacer, a bottom and top parts, a actuator tine and a pull-tab are made from metal; optionally the metal is zinc alloys, zamak 2, zamak 3, or aluminum.

14. The module according to claim 5, wherein a size of the case is standardized to fit within a receptacle cage of an SFP-DD transceiver host.

15. An SFP-DD transceiver host comprising at least one SFPDD-MPM optical module according to claim 5.

16. A 25GS-PON-OLT comprising at least one SFP-DD transceiver host according to claim 15.

17. A XGS-PON-OLT comprising at least one SFP-DD transceiver host according to claim 15.

18. A GPON-OLT comprising at least one SFP-DD transceiver host according to claim 15.

19. A Multi-PON OLT comprising at least one SFP-DD transceiver host according to claim 15.
